(19) United States
(12) Patent Application Publication
(10) Pub. No.: US 2010/0162203 A1
(43) Pub. Date: Jun. 24, 2010

(54) PROJECT MANAGEMENT DEVICE AND METHOD FOR ARCHITECTURE MODELING TOOL OF APPLICATION SOFTWARE ON AUTOSAR AND COMPUTER READABLE RECORDING MEDIUM THEREFOR

(75) Inventors: Jeong Si KIM, Daejeon (KR); Tae Man Han, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/549,671

(22) Filed: Aug. 28, 2009

(30) Foreign Application Priority Data
Dec. 19, 2008 (KR) 10-2008-0130041

(51) Int. Cl. G06F 9/44

(52) U.S. Cl. 717/105

(57) ABSTRACT

Provided are a project management device and a method for an architecture modeling tool of AUTOSAR application software. The device includes an interface unit, a command execution unit, and a workspace management unit. The interface unit receives a processing command affecting project resources from a user, classifies the received command, and executes a corresponding call processing. The command execution unit analyzes a command inputted from the interface unit or delivered from a tool. If the command is a tool stop command, the device is stopped. If the command is an interface input command or is not the tool stop command, the command is classified into a description resource build command and a model update command to be executed. The workspace management unit creates, deletes, and updates contents of a workspace to reflect a processing result executed by the command execution unit on the workspace.

### CROSS-REFERENCE TO RELATED APPLICATIONS

This application claims priority under 35 U.S.C. §119 to Korean Patent Application No. 10-2008-0130041, filed on Dec. 19, 2008, in the Korean Intellectual Property Office, the disclosure of which is incorporated herein by reference in its entirety.

### TECHNICAL FIELD

The present disclosure relates to a project management device and a project management method, and in particular, to a project management device, a project management method, and a computer readable recording medium therefor, which manage software architecture model data resources and Automotive Open System Architecture (AUTOSAR) description data resources, and project self-attribute resources, processed by an AUTOSAR application software architecture modeling tool supporting AUTOSAR model and development methodology in connection with the AUTOSAR application software architecture modeling tool.

### BACKGROUND

As functions of electronic control units (ECUs) that control automotive electrical and electronic systems have become more complex, development of ad-hoc ECU software has become more difficult. Since automobile manufacturers face shorter Time-to-Market and effective development cost requirements, and must satisfy real-time contractual obligations and safety requirements, Automotive Open System Architecture (AUTOSAR) standards have been established to help them meet these requirements.

Generally, in order to develop AUTOSAR application software based on models and development methodology proposed in the AUTOSAR standards, various authoring tools are required. Among the various authoring tools, an AUTOSAR application software architecture modeling tool (a tool for supporting AUTOSAR application software development at an early stage) supports modeling of elements, ports, interfaces and connectors, and architectural relation modeling therebetween.

A project management device for a typical tool, which is a device for managing resources processed in operations provided in a corresponding tool environment, has different configuration and processing manners according to the fields supporting the tool. This is because the work target resources provided in the tool environment are varied according to fields supporting the tool.

It is necessary for a user to intuitively confirm and architecturally store model data resources created in modeling work provided by the modeling tool through an efficient user interface. AUTOSAR description resources outputted from the model data resources also need to be managed.

However, because existing project management technologies are used to perform a portion of the project management function for a general development tool domain, or for project management technology (software development), the existing project management technologies are unable to provide a user with an intuitive management environment for resources treated in work performed by tools, in regard to storing management of AUTOSAR application software architecture model data resources or output processing management.

### SUMMARY

In one general aspect, a project management device for an architecture modeling tool of Automotive Open System Architecture (AUTOSAR) application software includes: an interface unit receiving a processing command affecting project resources from a user, classifying the received command, and executing a corresponding call processing; a command execution unit analyzing a command inputted from the interface unit or delivered from a tool, wherein, if the command is a tool stop command, the command execution unit stops the device, and if the command is not the tool stop command or if the command is an interface input command, the command execution unit classifies the command into a description resource build command and a model update command and executes the command accordingly; and a workspace management unit creating, deleting, and updating contents of a workspace when a processing result executed by the command execution unit should be reflected on the workspace.

In another general aspect, a project management method for an architecture modeling tool of AUTOSAR application software includes: determining whether a command is received from a tool or an interface by receiving and classifying the command; determining whether the command is a description resource build command or a model update command by analyzing the command if the command is determined to be received from the interface; storing updated resources after updating corresponding resources according to the description resource build command or the model update command to express the updated resource; and storing project attribute resources in a workspace by updating the project attribute resources if a processing according to the description resource build command or the model update command is completed.

In another general aspect, a computer readable recording medium for storing a program executes determining whether a command is received from a tool or an interface by receiving and classifying the command; determining whether the command is a description resource build command or a model update command by analyzing the command if the command is determined to be received from the interface; storing updated description resources or updated model resources in the workspace after updating description resources or corresponding resources of port, connector, and interface models according to the updated model component, and updating description resource-related interface or model resource-related interface to express the updated resources; and storing updated project attribute resources in the workspace after updating the project attribute resources maintaining attribute information on all resources and architectures of elements included in the project management device if a resource-related processing of elements of the project management device according to the description resource build command or the model update command is completed.

Other features and aspects will be apparent from the following detailed description, the drawings, and the claims.

### BRIEF DESCRIPTION OF THE DRAWINGS

FIG. 1 is a block diagram illustrating a project management device for a software architecture modeling tool according to an embodiment.

FIG. 2 is a flowchart illustrating a project management method for a software architecture modeling tool according to an embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

The exemplary embodiments set forth herein may be performed on a readable program or a recording medium storing a program in a computer or other equivalent digital devices. That is, in order to perform an exemplary embodiment, a computer or other equivalent digital devices may run a program to execute a project management method for a software architecture modeling tool of AUTOSAR application software.

Hereinafter, in order to fully convey the scope of the present invention to those skilled in the art, preferred embodiments will be described in detail with reference to the accompanying drawings. Like reference numerals refer to like elements throughout. Descriptions of repeated elements will be omitted.

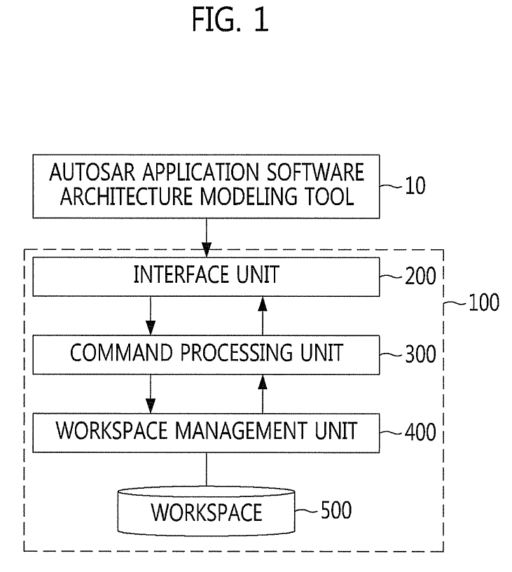

FIG. 1 is a block diagram illustrating a project management device for a software architecture modeling tool according to an embodiment.

Referring to FIG. 1, a project management device 100 for a software architecture modeling tool includes an interface unit 200, a command execution unit 300, a workspace management unit 400, and a workspace 500.

The interface unit 200 receives a command from a user, and classifies the command to execute a corresponding call processing. The interface unit 200 provides an input interface for possible commands from a user in advance.

The possible commands include model resource creation and deletion, and description resource build. The model resource includes component, port, connector, interface, and architectural resource therebetween.

The interface unit 200 outputs a command to visually express changes of work resources of a tool, which is a result of execution of the inputted command or a command delivered from the tool, and updates a description resource-related interface or a model resource-related interface.

The command execution unit 300 analyses the commands inputted from the interface unit 200, or the commands delivered from the tool. If the command is a tool stop command, the device is stopped. If the command is not a tool stop command, or if the command is an interface input command, the command is classified into a description resource build command and a model update command, and the corresponding command is executed.

The description resource build command is a command to create description resources using model resources. The model update command is a command to create or delete the model resources, or to modify the model.

The workspace management unit 400 creates, deletes, and updates the contents of the workspace 500 if the contents processed by the command execution unit 300 should be reflected in the workspace 500. The workspace 500 refers to a physical storage space for storing tool work resources managed by the project management device 100 in the form of file.

Hereinafter, an operational process according to an embodiment will be described with reference to the accompanying drawings.

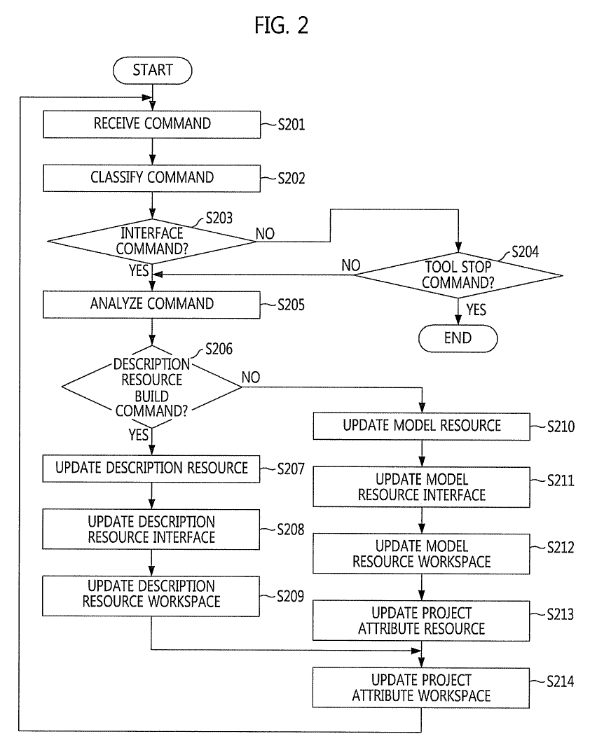

FIG. 2 is a flowchart illustrating a project management method for a software architecture modeling tool according to an embodiment.

Referring to FIG. 2, an interface unit 200 of a project management device 100, which is started with a tool 10, receives a command from an input interface for a user or from the tool 10 in step S201. Upon receiving a command, the interface unit 200 classifies and outputs the received commands in step S202.

Then, a command execution unit 300 determines whether the classified command is a command received from the tool 10 or from the input interface in step S203.

If the command is a command received from the tool 10 according to the determination result of step S203, it is determined whether the command is a tool stop command in step S204.

If the command is the tool stop command according to the determination result of step S204, the project management device 100 is stopped. If the command is other than the tool stop command, the command is analyzed in step S205, and determined whether it is a description resource build command or a model update command in step S206.

If the command is a command received from the input interface according to the determination result of step S203, the command is analyzed in step S205, and determined whether the command is a description resource build command or a model update command in step S206.

If the command is the description resource build command according to the determination result of step S206, description resources are updated in step S207 according to execution of the description resource build command. Then, a description resource-related interface is updated by the interface unit 200 to express the updated description resources in step S208.

Next, a workspace 500 is updated by the workspace management unit 400 to reflect the updated description resources in step S209.

If the command is the model update command according to the determination result of step S206, corresponding resources of port, connecter, and interface models are updated according to an updated model component in step S210. Then, a model resource-related interface is updated by the interface unit 200 to express the updated model resources in step S211.

Thereafter, a workspace 500 is updated to reflect the updated model resources by the workspace management unit 400 in step S212.

If the resource-related processing of elements of the project management device 100 is completed according to the description resource build command or the model update command, the command execution unit 300 updates project attribute resources maintaining all attribute information on resources and architectures included in the project management device 100 in step S213. Then, the workspace 500 is updated by the workspace management unit 400 to reflect the updated project attribute resources in step S214.

The project management method as described above can be implemented as a program and stored in a computer readable recording medium (e.g., CD ROM, RAM, floppy disk, hard disk, optical magnetic disk, and flash memory, etc.).

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A project management device for a software architecture modeling tool of Automotive Open System Architecture (AUTOSAR) application software, the device comprising:
an interface unit receiving a processing command affecting project resources from a user, classifying the received command, and executing a corresponding call processing;
a command execution unit analyzing a command inputted from the interface unit or delivered from a tool, wherein, if the command is a tool stop command, the command execution unit stops the device, and if the command is not the tool stop command or if the command is an interface input command, the command execution unit classifies the command into a description resource build command and a model update command and executes the command accordingly; and
a workspace management unit creating, deleting, and updating contents of a workspace when a processing result executed by the command execution unit should be reflected on the workspace.

2. The project management device of claim 1, wherein the interface unit provides with an input interface of possible commands inputted by a user in advance.

3. The project management device of claim 2, wherein the possible commands inputted by a user comprises creation and deletion of model resources, and building of description resources.

4. The project management device of claim 3, wherein the model resources comprises component, port, connector, interface, and architectural resources therebetween.

5. The project management device of claim 1, wherein the interface unit outputs a command for visually expressing an architectural change of work resources of the tool, which is an execution result of the command inputted from the interface unit or delivered from the tool.

6. The project management device of claim 1, wherein the description resource build command is a command for creating description resources using model resources, and the model update command is model resource creation, model resource deletion, or model modification.

7. The project management device of claim 1, wherein the workspace is a physical storage space for storing tool work resources managed by the project management device in file form.

8. A project management method for an architecture modeling tool of AUTOSAR application software, the method comprising:
determining whether a command is received from a tool or an interface by receiving and classifying the command;
determining whether the command is a description resource build command or a model update command by analyzing the command if the command is determined to be received from the interface;
storing updated resources after updating corresponding resources according to the description resource build command or the model update command to express the updated resource; and
storing project attribute resources in a workspace by updating the project attribute resources if a processing according to the description resource build command or the model update command is completed.

9. The project management method of claim 8, wherein the storing of updated resources comprises:
updating description resources according to an execution result of the description resource build command if the command is the description resource build command;
updating description resource-related interface to express the updated resources; and
storing the updated description resources in the workspace.

10. The project management method of claim 8, wherein the storing of the updated resources comprises:
updating corresponding resources of port, connector, and interface models according to the updated model component if the command is the model update command;
updating model resource-related interface to express the updated resources; and
storing the updated model resources in the workspace.

11. The project management method of claim 8, wherein the storing of project attribute resources comprises:
determining whether a resource-related processing of elements of the project management device according to the description resource build command or the model update command is completed;
updating project attribute resources maintaining attribute information on all resources and architectures of elements comprised in the project management device; and
storing the updated attribute resources in the workspace.

12. The project management method of claim 8, wherein, if the command received from the tool is other than a tool stop command, it is determined whether the command is the description resource build command or the model update command, and if the command is the tool stop command, the device is stopped.

13. The project management method of claim 8, wherein the description resource build command is a command for creating description resources using model resources.

14. The project management method of claim 8, wherein the model update command is model resource creation, model resource deletion, or model modification.

15. A computer readable recording medium for storing a program, executing:
determining whether a command is received from a tool or an interface by receiving and classifying the command;
determining whether the command is a description resource build command or a model update command by analyzing the command if the command is determined to be received from the interface;
storing updated description resources or updated model resources in the workspace after updating description resources or corresponding resources of port, connector, and interface models according to the updated model component, and updating description resource-related interface or model resource-related interface to express the updated resources; and
storing updated project attribute resources in the workspace after updating the project attribute resources maintaining attribute information on all resources and architectures of elements comprised in the project management device, if a resource-related processing of elements of the project management device according to the description resource build command or the model update command is completed.
